(19) United States
(12) Patent Application Publication
(10) Pub. No.: US 2014/0255138 A1
(43) Pub. Date: Sep. 11, 2014

(54) Ramp System for Installation in a Vehicle

(71) Applicant: AMF-BRUNS GMBH & CO. KG, Apen, DE (US)

(72) Inventor: Gerit Bruns, Bad Zwischenahn (DE)

(73) Assignee: AMF-Bruns GmbH & Co. KG, Apen, DE (US)

(21) Appl. No.: 13/856,720

(22) Filed: Apr. 4, 2013

(30) Foreign Application Priority Data
Mar. 7, 2013 (DE) 20 2013 002 152.7

(51) Int. Cl. A61G 3/06; B60P 1/43

(52) U.S. Cl. CPC A61G 3/061; B60P 1/43
USPC 414/537; 14/71.1

(57) ABSTRACT

A ramp system for installation on a vehicle, and a vehicle for conveying wheelchair users. The ramp system includes an intermediate element having a longitudinal guide and a ride-on access plate. The ride-on access plate is moveable from a vertical transport position to a horizontal stowage position by pivoting about a movable axis. A guide pin coupled to the ride-on access plate is guided by the longitudinal guide of the intermediate element as the ride-on access plate is moved from the vertical position to the horizontal position. The ramp system further includes a guide strut that is pivotally mounted to the ride-on access plate and the intermediate element. The movement of the ride-on access plate between the vertical and horizontal positions is thereby controlled relative to the intermediate element by the longitudinal guide and guide strut.

### TECHNICAL FIELD

The present invention relates generally to a ramp system for installation in a vehicle that permits ride-on access of a mobile object into an interior of the vehicle, and in particular to a ramp system that provides access to the interior of the vehicle by a wheelchair.

### BACKGROUND

Ramp systems for vehicles typically comprise at least one intermediate element which is coupled to the vehicle, and a ride-on access plate coupled to the at least one intermediate element. The ride-on access plate is configured to be moved from a vertical transport position into a horizontal stowage position by means of a rotary movement about a pivot axis. Ramp systems of this kind have been installed for some time in private automobiles and small transport vehicles or vans in order to afford a wheelchair user easier access to the interior or the transport region of the vehicle. These ramp systems also typically allow the vehicle to have sufficient stowage space and a usable floor area when a wheelchair user is not being transported.

In that respect, known ramp systems are generally displaceable between three positions. In a first position that provides ride-on access to the vehicle, the ride-on access plate is inclined relative to a horizontal plane, and thus bridges over the difference in height between a floor-level entry edge of the vehicle interior and the level of the road or pathway from which the rider is entering the vehicle. The inclined ride-on access plate thus allows the wheelchair user to roll into the transport interior of the vehicle independently, or with the assistance of a care giver.

After the wheelchair user has entered the vehicle, the ride-on access plate is moved into a transport position in which the plate is arranged into a substantially vertical position. After reaching the destination, the ride-on access plate is moved again from the vertical transport position into the ride-on access position in which it is inclined relative to horizontal to permit the wheelchair user to exit the transport vehicle.

If the vehicle equipped with such a ramp system is not being used for conveying wheelchair users, the ride-on access plate of the ramp system can be moved into a lying stowage position. In the stowage position, the ride-on access plate is in the floor region of the vehicle interior so that a large part of the vehicle's stowage space is available again.

To keep the inclination of the ride-on access plate slight when the access plate is in the ride-on access position, the entry edge over which the wheelchair user passes into the vehicle interior is typically arranged to be as low as possible. To this end, the entry edge is usually arranged below the inside vehicle floor on which, for example, the vehicle seats are fitted. So that the ride-on access plate is approximately level with the inside vehicle floor in the stowage position, known ramp systems require intermediate elements which can compensate for the difference in height between the entry edge and the inside vehicle floor. These known ramp systems often use a large number of mechanical components for that purpose, such as inter-nested sliding guides. The combination of a large number of parts and a complicated mechanism leads to an increased risk of failure as well as an increased risk of functional faults or troubles. In addition, known mechanical implementations using inter-nested sliding guides may also lead to an increased risk of injury during use of such ramp systems. These known implementations also tend to require increased structural space due to the large number of parts. The resulting complicated mechanism often requires non-standard components, which are not optimised in terms of production, thereby increasing the manufacturing costs of such ramp systems.

### SUMMARY

Embodiments of the invention address the above-mentioned disadvantages by providing an improved ramp system, and a vehicle having the ramp system, which allow use of the vehicle to convey wheelchair users without impacting seriously on stowage space when the vehicle used in other ways.

In a first aspect of the invention, a vehicle access ramp system includes a ride-on access plate having at least one guide pin guided in a longitudinal guide of the at least one intermediate element, and at least one guide strut pivotably mounted between the intermediate element and the ride-on access plate. The ride-on access plate is thus guided in relation to the intermediate element by the guide pin in the longitudinal guide of the intermediate element, and is movable relative thereto. In conjunction with the guide strut, the rotary movement of the ride-on access plate about the first movable pivot axis can be implemented by a mechanism which is simpler and has a smaller number of parts in comparison with the state of the art.

In an embodiment of the ramp system, the ride-on access plate can be moved from an inclined ride-on access position into the vertical transport position by means of a rotary movement about an additional pivot axis. The movable pivot axis and the additional pivot axis may permit mounting of the ramp system in a plane which is lowered in relation to the floor of the vehicle interior. The ramp system may thereby provide a moderate angle of inclination of the ride-on access plate in the ride-on access position, and level positioning of the ride-on access plate with the inside vehicle floor in the stowage position. In this embodiment, the inclination of the ride-on access plate in the ride-on access position may be dependent on the relationship between the difference in height to be bridged over by the ramp and the length of the ride-on access plate.

In another embodiment, the ride-on access plate may be coupled to two intermediate elements, each intermediate element having a longitudinal guide. The two intermediate elements may be arranged in an opposing relationship at the outside surfaces of the ride-on access plate. In this embodiment, two mutually opposed guide pins may be arranged on the ride-on access plate so that each guide pin is guided in the longitudinal guide of the respective intermediate element. Guidance for the ride-on access plate on both sides of the plate may provide for increased stability and thus an increased service life as compared to ramp systems lacking this feature.

In yet another embodiment of the ramp system, the two intermediate elements may be coupled by an intermediate plate. The intermediate plate may be configured so that when the ramp system is in either of the ride-on access and transport positions, the intermediate plate is arranged parallel to, and may also come into contact with, the ride-on access plate. In embodiments including the intermediate plate, the intermediate plate may be spaced from the ride-on access plate in such a way that the intermediate plate extends the ride-on access plate without the presence of a slot between the plates. The intermediate plate may be further configured so that the intermediate plate is arranged perpendicularly to the ride-on access plate while the ride-on access plate is in the stowage position.

In yet another embodiment, the ramp system includes two guide struts which extend in a parallel and mutually opposing relationship at the outside surfaces of the ride-on access plate. The presence of guide struts on both sides of the ride-on plate may have a positive effect on the stability of the ramp system during displacement of the ride-on access ramp between the various positions. The guide struts may also work in combination with the intermediate elements and the guide pins, which are disposed at both sides of the ride-on plate and engage into the longitudinal guide thereof, to improve guidance precision of the ride-on access plate.

In yet another embodiment of the ramp system, the movable pivot axis is coincident with the horizontal central axis of the guide pin or pins. The orientation and arrangement of the movable pivot axis is consequently limited by the longitudinal guides of the intermediate elements.

In yet another embodiment of the ramp system, the at least one guide strut may be configured so that the guide strut is arranged in a substantially vertical position while the ramp system is in the transport position, and arranged at an incline relative to the vertical position while the ramp system is in the transport position so that in the ride-on access position, the at least one guide strut has substantially the same inclination relative to horizontal as the ride-on access plate. Thus, when the ramp system is in either of the ride-on access or transport positions, the guide strut is oriented parallel to the central axis of the ride-on access plate. This may permit a space-saving implementation of a motion mechanism. In the stowage position, the ride-on access plate may be supported by the inclined arrangement of the guide strut so that the ride-on access plate can be loaded even without further mounting or support elements. As no further support or mounting elements are required, the ramp system on the one hand is further simplified and on the other hand can be subjected to loads.

In yet another embodiment of the ramp system, the at least one guide strut may lie on the at least one intermediate element while the ramp system is in either of the transport or the ride-on access positions. This relationship may reduce the space required for the ramp system as well as reduce the risk of injury to users by lessening the risk of hands or fingers being squashed as compared to ramp systems lacking this feature.

In yet another embodiment of the ramp system, the vertical outside surfaces of the guide struts and the lateral outside surfaces of the ride-on access plate may be disposed in the same plane. Thus, depending on the thickness of the guide struts and the configuration of the outside surfaces of the ride-on access plate, the ramp system may provide a motion mechanism having a slender structure so that the space required for the motion mechanism is reduced and/or it is possible to use a widened ride-on access plate.

In an exemplary embodiment of the ramp system, the intermediate element and a guide strut arranged on the same side of the ride-on access plate may have a collective width of below 20 mm, and preferably below 15 mm.

In another embodiment of the ramp system, the at least one guide pin may be disposed in a first end position in the at least one longitudinal guide while the ramp system is in either of the transport and ride-on access positions, and in a second end position in the at least one longitudinal guide when the ramp system is in the stowage position. Consequently the longitudinal guide is able to guide the guide pin between the first end position and the second end position. As used herein, the term end position means a position in which the guide pin cannot continue with an implemented movement in the longitudinal guide because the movement is limited in positively locking relationship by the presence of an end edge of the longitudinal guide.

In another embodiment of the ramp system, the at least one longitudinal guide may have a partly curved configuration or portion. The curved configuration or portion of the longitudinal guide may provide a mechanism for influencing the movement of the ride-on access plate when moving between the two different end positions. The curved guide may thereby avoid jamming of the ride-on access plate with other parts of the ramp system and/or the vehicle, while reducing the size of the opening between the intermediate plate and the ride-on access plate when the ramp system is in the stowage position.

In another embodiment of the ramp system, an end seat is provided at one end the at least one longitudinal guide. The end seat may be formed by a 90 degree curve in the longitudinal guide, and may allow positively locking positioning and/or latching of the guide pin in the stowage position. The ride-on access plate may thereby be secured in the horizontal orientation in such a way that the ride-on access plate cannot be moved out of the horizontal position by being acted upon with vertical forces. This may allow the ride-on access ramp to be reliably and safely loaded in the stowage position without the danger of the ride-on access plate moving into another position by virtue of being acted upon with vertical forces due to the ride-on access plate being loaded with objects.

In another embodiment of the ramp system, the ride-on access plate may be lockable in the transport position. This feature may prevent unintended movements of the ride-on access plate. Consequently, the level of security and safety when using the ramp system may be increased as compared to ramp systems lacking this feature.

In another embodiment of the ramp system, one locking mechanism locks and enables displacement of the ride-on access plate from the transport position into the ride-on access position, and another locking mechanism locks and enables displacement of the ride-on access plate from the transport position into the stowage position. The two separate locking mechanisms may provide increased operational reliability and safety, and may reduce the risk of ramp system failure as compared to a ramp system having a single locking mechanism.

In another embodiment of the ramp system, the one locking mechanism may be displaceable by way of one actuating lever, and the additional locking mechanism may be displaceable by way of another actuating lever. The separate actuating levers may be operated manually, and may increase both the convenience of using of the ramp system and permit quick uncomplicated handling.

Embodiments of the invention may also include a vehicle for conveying wheelchair users, which has a ramp system as set forth herein.

### BRIEF DESCRIPTION OF THE FIGURES

Further features and advantages of the invention will be apparent from the accompanying claims and the description hereinafter in which an embodiment by way of example is described in detail by reference to the drawings in which:

FIG. 1 shows a perspective view of an embodiment of the ramp system according to the present invention in the ride-on access position in conjunction with a vehicle,

FIG. 2 shows a detailed perspective view of the ramp system in the ride-on access position,

FIG. 3 shows a side view of the ramp system in the ride-on access position in conjunction with the vehicle,

FIG. 4 shows a detailed side view of the ramp system,

FIG. 5 shows a perspective view of the ramp system in the transport position in conjunction with the vehicle,

FIG. 6 shows a detailed perspective view of the ramp system in the transport position,

FIG. 7 shows a side view of the ramp system in the transport position in conjunction with the vehicle,

FIG. 8 shows a detailed side view of the ramp system in the transport position,

FIG. 9 shows a perspective view of the ramp system in the stowage position in conjunction with the vehicle,

FIG. 10 shows a detailed view of the ramp system in the stowage position,

FIG. 11 shows a side view of the ramp system in the stowage position in conjunction with the vehicle, and

FIG. 12 shows a detailed side view of the ramp system in the stowage position.

The accompanying drawings, which are incorporated in and constitute a part of this specification, illustrate various embodiments of the invention and, together with a general description of the invention given above and the detailed description of the embodiments given below, serve to explain the embodiments of the invention.

### DETAILED DESCRIPTION

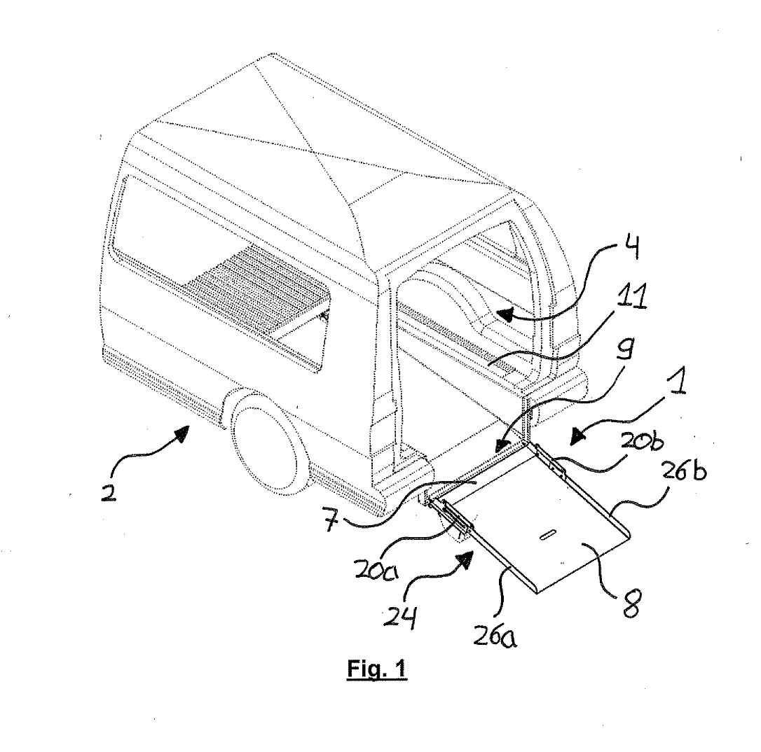

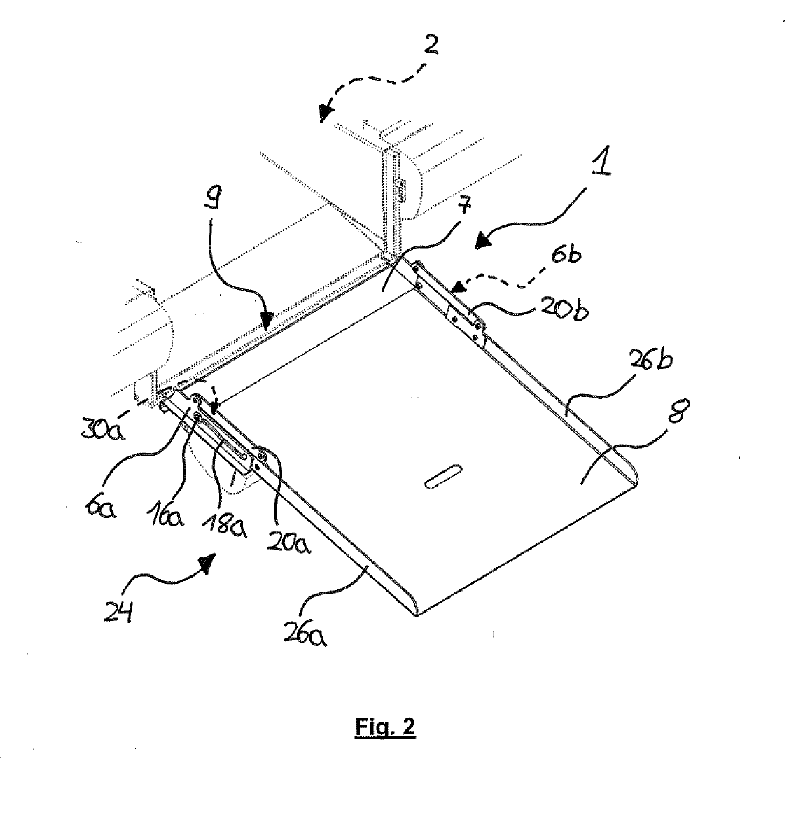

FIG. 1 shows an exemplary ramp system 1 installed in a vehicle 2. In the depicted embodiment, a ride-on access plate 8 of the ramp system 1 is in an inclined ride-on access position 24. In the illustrated ride-on access position 24, the ride-on access plate 8 is inclined with respect to a vertical plane. The ride-on access plate 8 thereby bridges over the difference in height between the road or the pathway on which the vehicle 2 is positioned, and a lowered entry edge 9 of the interior 4 of the vehicle. The lowered entry edge 9 in this exemplary embodiment is arranged lower than the inside vehicle floor 11 on which, for example, the driver and passenger seat may be mounted. This difference in height between the inside vehicle floor 11 and lowered entry edge 9 is caused by a ramp-like access in the interior 4 of the vehicle 2. The ramp-like access may have substantially the same inclination as the ride-on access plate 8 of the ramp system 1 in the ride-on access position 24. An intermediate plate 7 may be arranged between the ride-on access plate 8 and the lowered entry edge 9. The intermediate plate 7 connects the intermediate elements 6a, 6b (FIG. 2) to each other. The intermediate elements 6a, 6b may be present on both sides of ramp system 1, and may be connected to the ride-on access plate 8 or the outside surfaces 26a, 26b of the plate 8 by guide struts 20a, 20b.

As best shown in FIG. 2, the intermediate elements 6a, 6b are connected to the ride-on access plate 8 not only by the guide struts 20a, 20b, but also by longitudinal guides 18a, 18b (18b is hidden). The longitudinal guides 18a, 18b may be arranged on the intermediate elements 6a, 6b, and may be configured to engage guide pins 16a, 16b (16b is hidden). The guide pins 16a, 16b may in turn be coupled to the ride-on access plate 8. The ride-on access plate 8 and the intermediate plate 7 may provide a constant incline, which in the illustrated example is between about 15° and 25°. In this case, one side of the intermediate plate 7 terminates flush with the lowered entry edge 9 of the vehicle 2. In this arrangement, the outside surfaces 30a, 30b (30b is hidden) of the guide struts 20a, 20b may be arranged in substantially the same vertical plane as the outside surfaces 26a, 26b of the ride-on access plate 8.

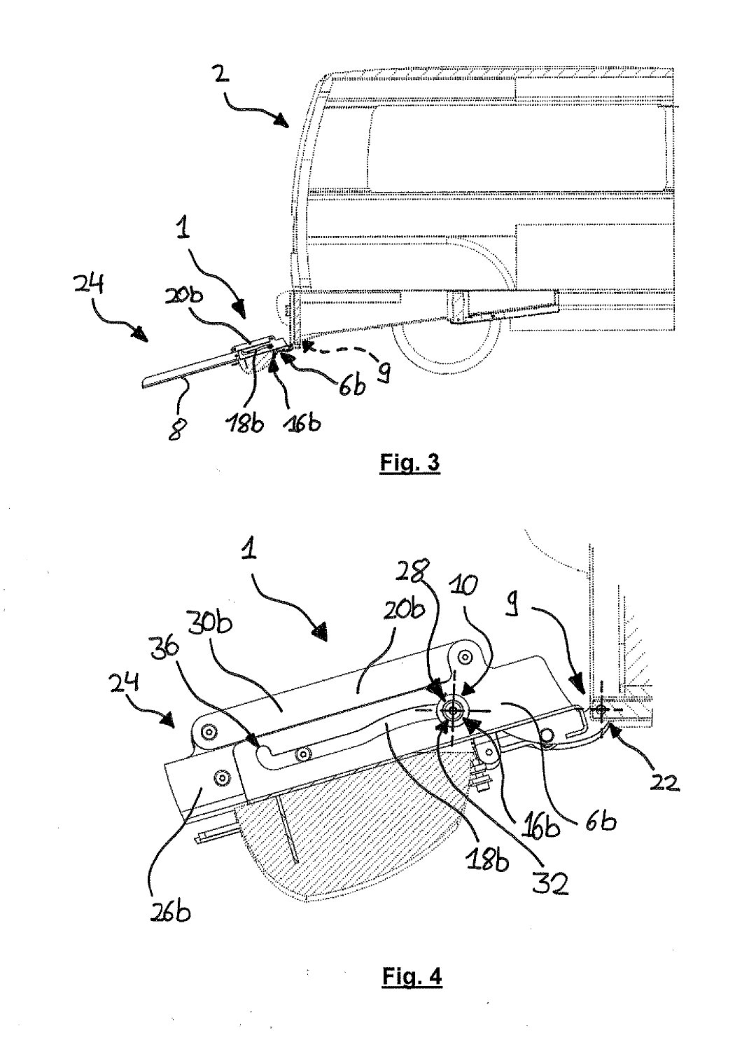

The side view illustrated in FIG. 3 shows the inclination of the ride-on access plate 8 with respect to the horizontal plane in the illustrated inclined ride-on access position 24.

The functional mechanism of the ramp system 1 is shown as a detailed side view in FIG. 4. A movable pivot axis 10 is coincident in this embodiment with the central axis 28 of the guide pins 16a, 16b. In the illustrated inclined ride-on access position 24 of the ride-on access plate 8, the guide pins 16a, 16b are in an end position 32 in the longitudinal guides 18a, 18b. The longitudinal guides 18a, 18b are of a partially curved or bent configuration, and/or include a curved or bent portion. At one end, the longitudinal guides 18a, 18b have an end seat 36 provided by a 90° bend or kink in the longitudinal guides 18a, 18b. In the illustrated embodiment, the intermediate elements 6a, 6b are pivotably coupled to the vehicle 2, wherein the pivotal movement of the intermediate elements 6a, 6b can be performed about another pivot axis 22. By virtue of the coupling of the ride-on access plate 8 to the intermediate elements 6a, 6b by the guide pins 16a, 16b, and the interaction of the guide pins 16a, 16b with the longitudinal guides 18a, 18b, a pivotal movement of the intermediate elements 6a, 6b about the pivot axis 22 also results in a pivotal movement of the ride-on access plate 8 about the pivot axis 22.

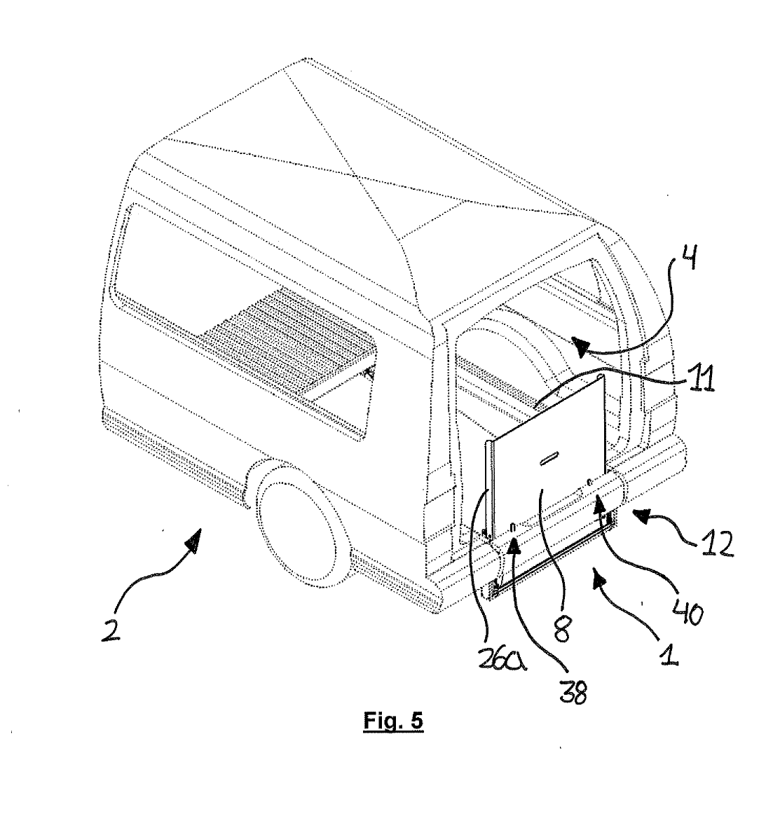

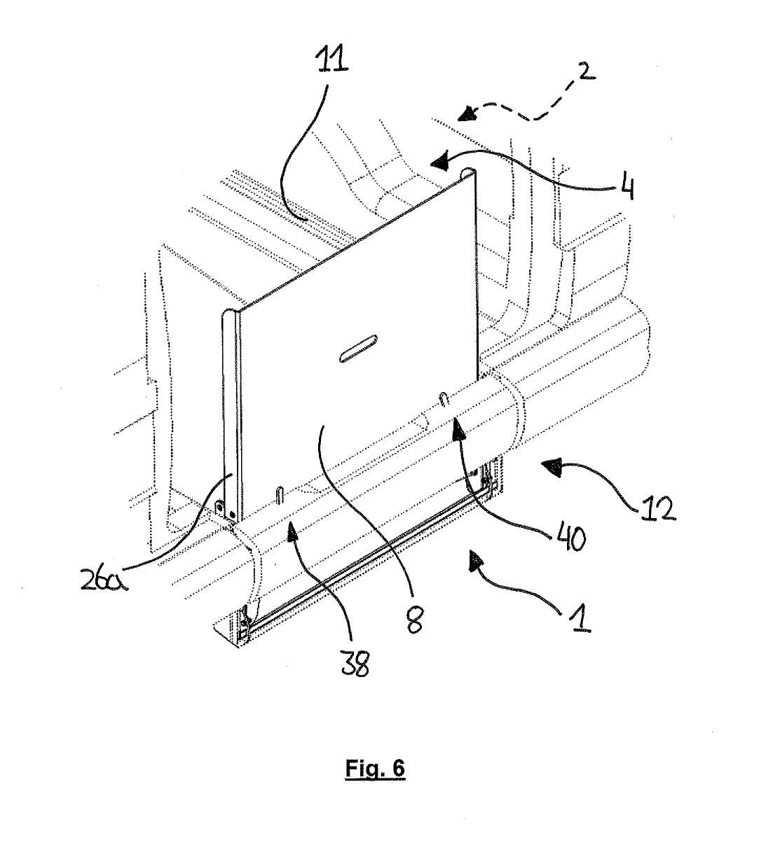

The transport position 12 of the ride-on access plate 8 as shown in FIGS. 5 and 6 can be adjusted by the pivotal movement of the ride-on access plate 8. The ride-on access plate 8 may be oriented substantially vertically in the transport position 12. In the illustrated embodiment, actuating levers 38, 40 are arranged in a plane that is parallel to the ride-on access plate 8, and which is spaced from the ride-on access plate 8 in the direction of the rear end of the vehicle.

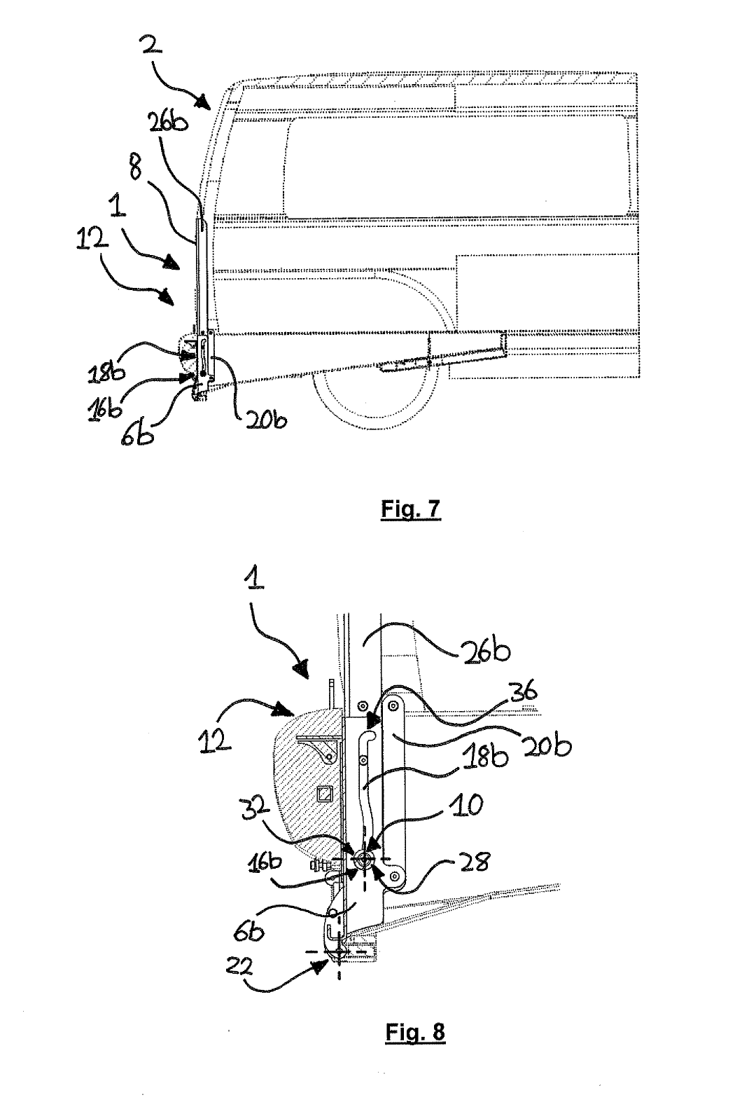

The side views of the ramp system 1 in FIG. 7 and FIG. 8 show the vertical orientation of the ride-on access plate 8 in the transport position 12. As the pivotal movement from the inclined ride-on access position 24 into the transport position 12 only entails a rotary movement of the ride-on access plate 8 about the pivot axis 22, the guide pins 16a, 16b are disposed in the first end position 32 in the longitudinal guides 18a, 18b in both the transport position 12, and in the inclined ride-on access position 24. Accordingly, the guide struts 20a, 20b extend parallel to the outside surfaces 26a, 26b of the ride-on access plate 8, and the outside surfaces 30a, 30b of the guide struts 20a, 20b extend substantially in the same vertical plane as the outside surfaces 26a, 26b of the ride-on access plate 8.

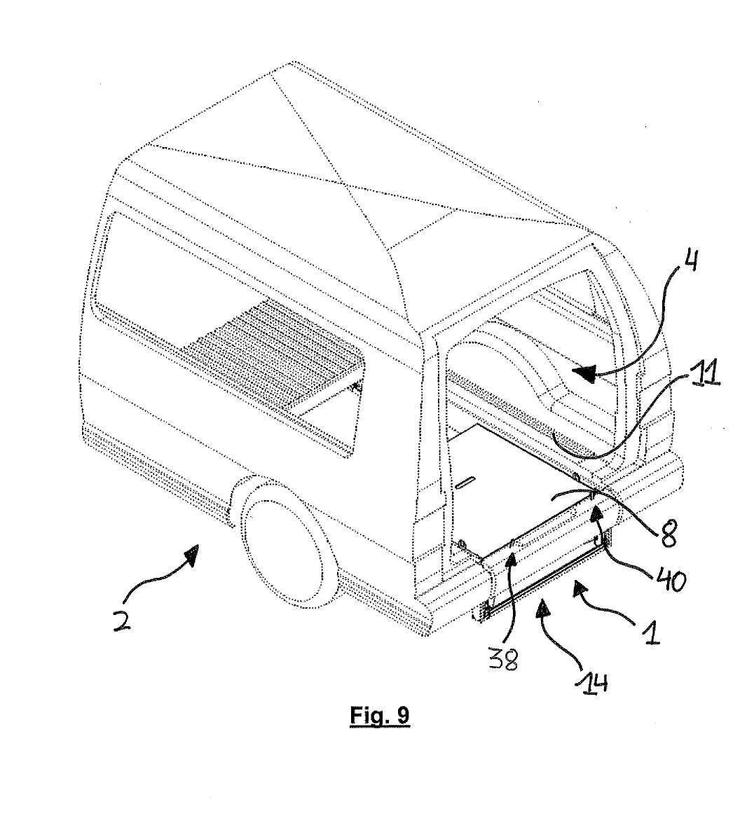

To move the ride-on access plate from the transport position 12 into the stowage position 14, the ride-on access plate 8 is moved about the movable pivot axis 10. As shown in FIG. 9, the ride-on access plate 8 is arranged in the stowage position 14 in a substantially horizontal plane, and terminates substantially flat with the inside vehicle floor 11.

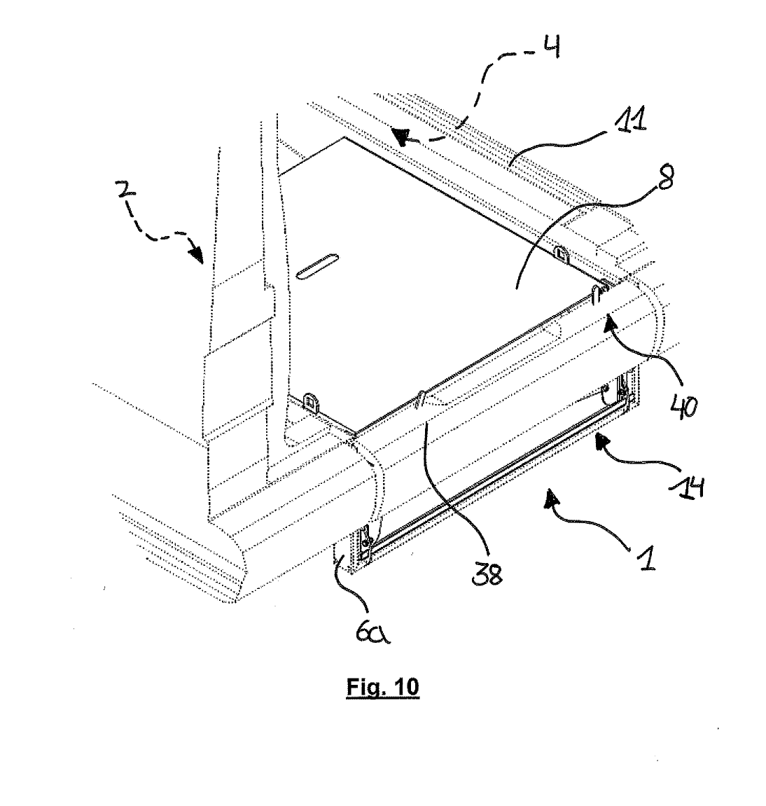

As shown in FIGS. 9 and 10, the intermediate elements 6a, 6b of the ride-on access plate 8 extend in a substantially vertical direction while the ramp system 1 is in the stowage position. FIGS. 9 and 10 also show that the surface of the ride-on access plate 8, which faces upwardly in the stowage position 14, is arranged in the stowage position 14 in substantially the same plane as the inside vehicle floor 11.

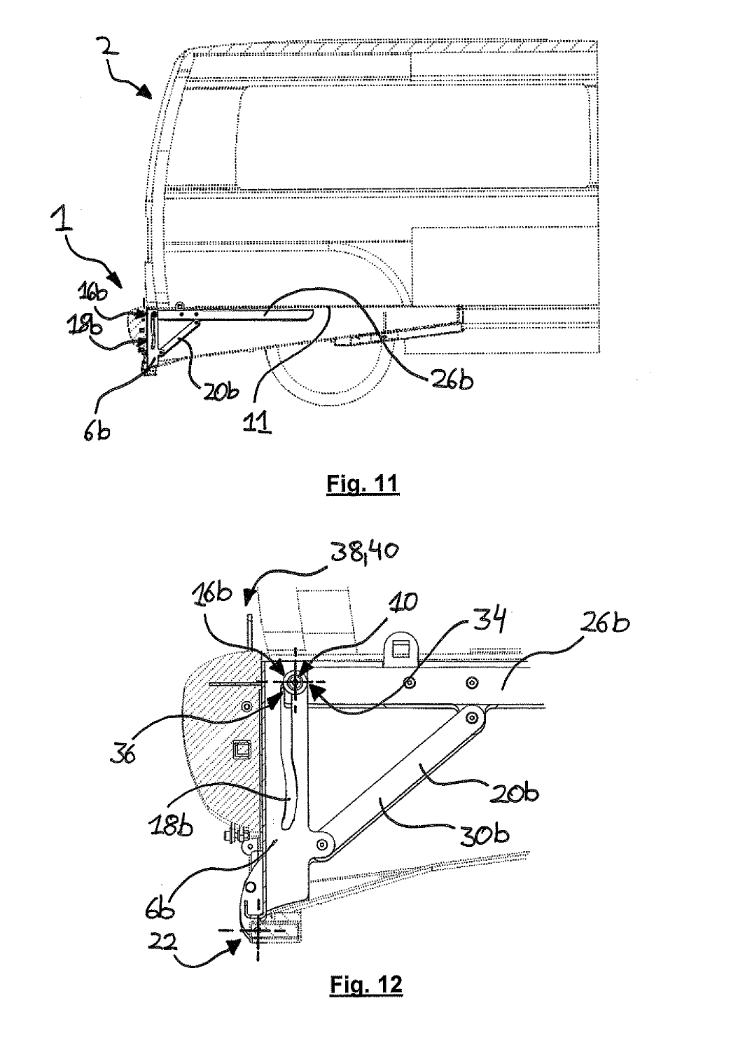

The side views in FIGS. 11 and 12 show that upon a change in position of the ride-on access plate 8 from the transport position 12 into the stowage position 14, the movable pivot axis 10 and the guide pins 16a, 16b move along the longitudinal guides 18a, 18b from the end position 32 into the end position 34. Because the intermediate elements 6a, 6b have not changed their position, the guide struts 20a, 20b are moved from their vertical orientation into an inclined orientation relative to the vertical. In the illustrated embodiment, the guide struts 20a, 20b in the stowage position 14 are at an angle of approximately 45° both with respect to the intermediate elements 6a, 6b and also with respect to the ride-on access plate 8. In a manner not shown in the illustrated embodiment, the ride-on access plate 8 can be supported by the vehicle structure in the illustrated stowage position 14, such as by means of one or more supporting members.

### LIST OF REFERENCES

1 ramp system
2 vehicle
4 interior of the vehicle
6a, 6b intermediate element
7 intermediate plate
8 ride-on access plate
9 lowered entry edge
10 movable pivot axis
11 inside vehicle floor
12 transport position
14 stowage position
16a, 16b guide pin
18a, 18b longitudinal guide
20a, 20b guide strut
22 pivot axis
24 inclined ride-on access position
26a, 26b outside surface of the ride-on access plate
28 central axis of a guide pin
30a, 30b outside surface of a guide strut
32 end position of the guide pin
34 end position of the guide pin
36 end seat of a longitudinal guide
38 actuating lever
40 actuating lever

It will be understood that when an element is described as being “connected” or “coupled” to or with another element, it can be directly connected or coupled to the other element or, instead, one or more intervening elements may be present. In contrast, when an element is described as being “directly connected” or “directly coupled” to another element, there are no intervening elements present. When an element is described as being “indirectly connected” or “indirectly coupled” to another element, there is at least one intervening element present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A ramp system for installation in a vehicle, the ramp system having a ride-on access position, a transport position, and a stowage position, the ramp system comprising:
at least one intermediate element configured to be coupled to the vehicle, the at least one intermediate element including a longitudinal guide;
a ride-on access plate coupled to the at least one intermediate element, the ride-on access plate being moveable from a vertical transport position into a horizontal stowage position by rotary movement about a first pivot axis, the first pivot axis being moveable axis;
at least one guide pin coupled to the ride-on access plate, the at least one guide pin guided in the longitudinal guide of the at least one intermediate element; and
at least one guide strut pivotably mounted to the at least one intermediate element and the ride-on access plate so that the at least one guide strut couples the at least one intermediate element to the ride-on access plate.

2. The ramp system of claim 1 further comprising:
a second pivot axis,
wherein the ride-on access plate is configured to be moved from an inclined ride-on access position into the vertical transport position by rotary movement about the second pivot axis.

3. The ramp system of claim 1 wherein the ride-on access plate includes first and second outside surfaces, a first intermediate element of the at least one intermediate element is coupled to the first outside surface, and a second intermediate element of the at least one intermediate element is coupled to the second outside surface, the first and second intermediate elements being arranged in an opposing relationship at the outside surfaces of the ride-on access plate so that a first guide pin of the at least one guide pin is guided in the longitudinal guide of the first intermediate element, and a second guide pin of the at least one guide pin is guided in the longitudinal guide of the second intermediate element.

4. The ramp system of claim 3 further comprising:
an intermediate plate coupling the first and second intermediate elements, the intermediate plate configured to be arranged substantially parallel to the ride-on access plate while the ramp system is in the ride-on access and transport positions, and arranged substantially perpendicularly to the ride-on access plate while the ramp system is in the stowage position.

5. The ramp system of claim 3 wherein the at least one guide strut includes first and second guide struts that extend in a parallel arrangement, each of the first and second struts being coupled to the ride-on access plate and a respective one of the first and second intermediate elements, and being arranged in a mutually opposing relationship at the outside surfaces of the ride-on access plate.

6. The ramp system of claim 1 wherein the at least one guide pin has a central axis, and the first pivot axis is coincident with the central axis of the at least one guide pin.

7. The ramp system of claim 1 wherein the at least one guide strut is arranged along a substantially vertical orientation while the ramp system is in the transport position, the at least one guide strut is arranged at an incline relative to the substantially vertical orientation while the ramp system is in the stowage position, and the at least one guide strut is at substantially the same inclination as the ride-on access plate while the ramp system is in the ride-on position.

8. The ramp system of claim 1 wherein the at least one guide strut lies on the at least one intermediate element while the ramp system is in the transport and ride-on access positions.

9. The ramp system of claim 5 wherein each of the first and second guide struts includes a vertical outside surface disposed in the same plane as the respective lateral outside surface of the ride access plate.

10. The ramp system of claim 5 wherein at least one of the first and second intermediate elements and a corresponding one of the first and second guide struts that are arranged on the same side of the ride-on access plate have a collective horizontal width less than 20 mm.

11. The ramp system of claim 1 wherein the at least one guide pin is disposed in a first end position in the at least one longitudinal guide while the ramp system is in the ride-on and transport positions, and the at least one guide pin is disposed in a second end position in the at least one longitudinal guide while the ramp system is in the stowage position.

12. The ramp system of claim 1 wherein the longitudinal guide of the at least one intermediate element is at least partially of a curved configuration.

13. The ramp system of claim 1 one end of the longitudinal guide of the at least one intermediate element has an end seat which is formed by a 90 degree curve in the longitudinal guide.

14. The ramp system of claim 1 wherein the ride-on access plate is lockable in the transport position.

15. The ramp system of claim 14 further comprising:
a first locking mechanism configured to lock and enable displacement of the ride-on access plate from the transport position into the ride-on access position; and
a second locking mechanism configured to lock and enable displacement of the ride-on access plate from the transport position into the stowage position.

16. The ramp system of claim 15 further comprising:
a first actuating lever configured to displace the first locking mechanism; and
a second actuating lever configured to displace the second locking mechanism.

17. A vehicle for conveying wheelchair users, the vehicle comprising:
a ramp system including:
at least one intermediate element configured to be coupled to the vehicle, the at least one intermediate element including a longitudinal guide;
a ride-on access plate coupled to the at least one intermediate element, the ride-on access plate being moveable from a vertical transport position into a horizontal stowage position by rotary movement about a movable axis;
at least one guide pin coupled to the ride-on access plate, the at least one guide pin guided in the longitudinal guide of the at least one intermediate element; and
at least one guide strut pivotably mounted to the at least one intermediate element and the ride-on access plate so that the at least one guide strut couples the at least one intermediate element to the ride-on access plate.

18. The ramp system of claim 10 wherein the collective horizontal width is less than 15 mm.
